(19) United States
(12) Patent Application Publication
(10) Pub. No.: US 2026/0212743 A1
(43) Pub. Date: Jul. 23, 2026

(54) EMERGENCY LOCATION ALERT SYSTEM

(71) Applicant: Greg Verrall, Airdrie (CA)

(72) Inventor: Greg Verrall, Airdrie (CA)

(21) Appl. No.: 19/033,929

(22) Filed: Jan. 22, 2025

(51) Int. Cl. G08B 17/10; G08B 5/38; G08B 25/10; G08B 25/12; H04M 1/02

(52) U.S. Cl. CPC G08B 17/10; G08B 5/38; G08B 25/10; G08B 25/12; H04M 1/0291

(57) ABSTRACT

An alert system for indicating the location of an emergency includes a doorbell module with a housing which houses a processor. The doorbell module includes a light emitter which is mounted on the housing and is operably coupled to the processor. A manual actuator is operatively coupled to the processor and is positioned remotely from the doorbell module. The manual actuator is operable to selectively cause the processor to activate the light emitter.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to alert systems and more particularly pertains to a new alert system for indicating the location of an emergency.

### (2) Description of Related Art Including Information Disclosed Under 37 CFR 1.97 and 1.98

The prior art discloses various light apparatuses which may be mounted to an exterior of a dwelling and illuminated via various forms of actuation in order to indicate the location of an emergency to first responders. However, the prior art fails to describe such a system in which a doorbell module includes stroboscopic light emitters which may be activated when a security system identifies an emergency such as smoke from a fire or the presence of carbon monoxide.

### BRIEF SUMMARY OF THE INVENTION

An embodiment of the disclosure meets the needs presented above by generally comprising a doorbell module with a housing which houses a processor. The doorbell module includes a light emitter which is mounted on the housing and is operably coupled to the processor. A manual actuator is operatively coupled to the processor and is positioned remotely from the doorbell module. The manual actuator is operable to selectively cause the processor to activate the light emitter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a doorbell module of an alert system according to an embodiment of the disclosure.

FIG. 2 is a cross-sectional view of a doorbell module of an embodiment of the disclosure.

FIG. 3 is an in-use view of an embodiment of the disclosure.

FIG. 4 is a block diagram of an embodiment of the disclosure.

### DETAILED DESCRIPTION OF THE INVENTION

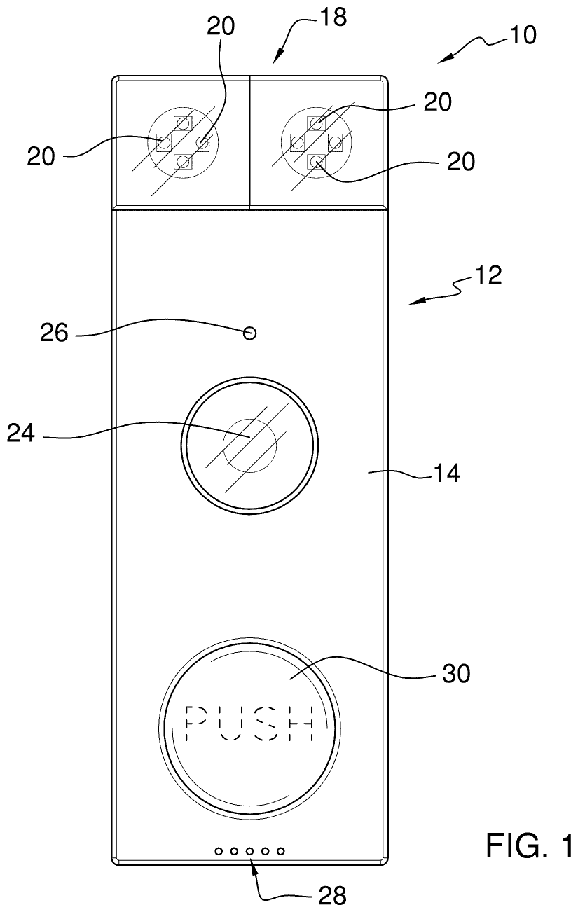

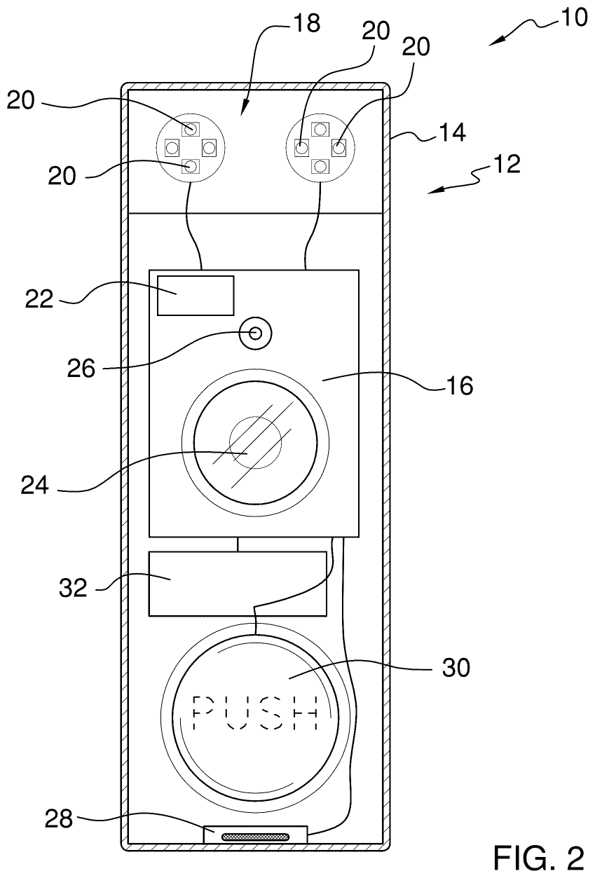

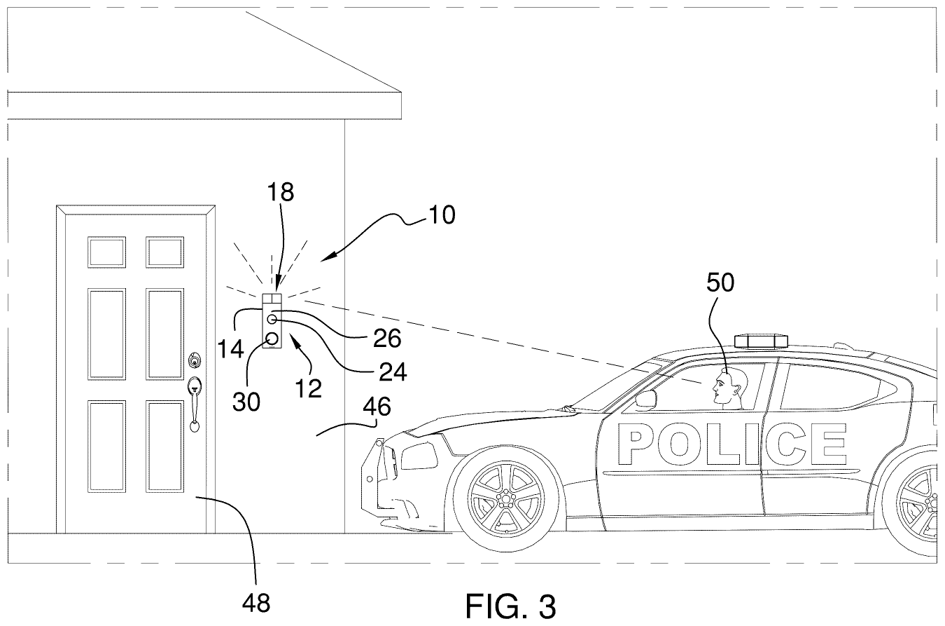

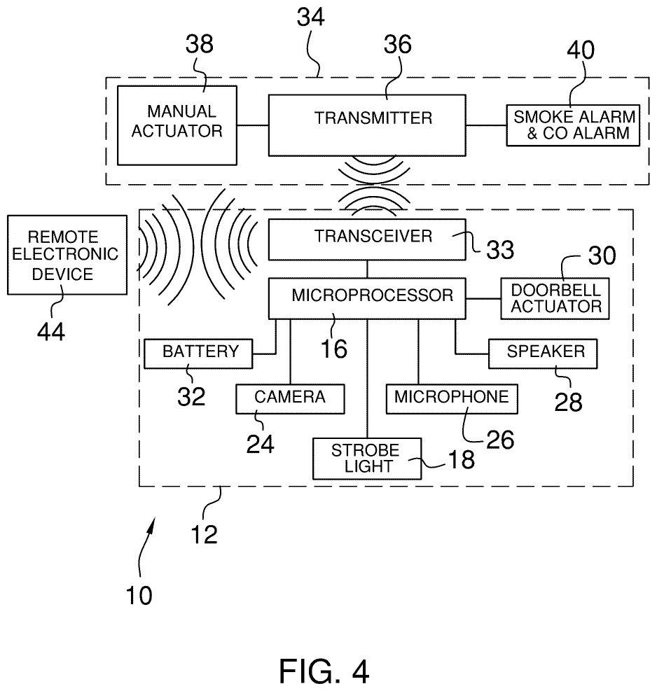

With reference now to the drawings, and in particular to FIGS. 1 through 4 thereof, a new alert system embodying the principles and concepts of an embodiment of the disclosure and generally designated by the reference numeral 10 will be described.

As best illustrated in FIGS. 1 through 4, the alert system 10 generally comprises a doorbell module 12 with a housing 14 that houses a processor 16. A light emitter 18 is mounted on the housing 14 and is operably coupled to the processor 16. The light emitter 18 comprises a plurality of emitting members 20 and is configured to emit a stroboscopic light pattern when activated. A transceiver 22 is mounted in the housing 14 and is operably coupled to the processor 16. The processor 16 is configured to wirelessly communicate with a remote electronic device 44 via the transceiver 22. A camera 24, a microphone 26, and a speaker 28 are mounted to the housing 14 and are operably coupled to the processor 16. A doorbell actuator 30 is mounted to the housing 14 and is operatively coupled to the processor 16. The doorbell actuator 30 comprises a button but may comprise a switch, a touchscreen, or another suitable input. A power supply 32 is mounted in the housing 14 and is electrically coupled to the processor 16. The power supply 32 comprises a battery but may comprise a capacitor or other suitable energy storage. In other embodiments, the processor 16 may be powered by connection to an external power supply 32.

The doorbell module 12 may be mounted to an exterior of a dwelling 46 near an entryway 48 to the dwelling 46. The processor 16 may be programmed to send a notification signal to the remote electronic device 44 when the doorbell actuator 30 is actuated in order to indicate that an individual is at the entryway 48. The remote electronic device 44 may be a smartphone, a tablet, a computer, or the like. The remote electronic device 44 includes an application with instructions to notify a user via audio, visual, haptic, or other signal that the notification signal was received. The processor 16 also may be programmed to cause another notification device such as a remote speaker 28, a remote light emitter 18, or the like to indicate that the doorbell actuator 30 was actuated via an audible signal, a visual signal, or the like. The processor 16 also may be programmed to cause the speaker 28 of the doorbell module 12 to emit an audible notification such as a chime when the doorbell actuator 30 is actuated to provide feedback to the operator of the doorbell actuator 30 that the notification signal was sent. The processor 16 communicates with the remote electronic device 44 via the transceiver 22 but may communicate via wires in other embodiments. The processor 16 may communicate to the other notification device via the transceiver 22 or a wired connection.

The processor 16 may be programmed to capture still images or video via the camera 24 and audio via the microphone 26 and transmit the same to the remote electronic device 44 when the doorbell actuator 30 is actuated. The application on the remote electronic device 44 may include instructions for recording audio from the remote electronic device 44 and transmit the same to the processor 16 via the transceiver 22 to be emitted by the speaker 28 via programming on the processor 16. In this manner, programming on the processor 16 and the application on the remote electronic device 44 may facilitate communication between the user and the individual at the entryway 48 of the dwelling 46.

An activation system 34 is operatively coupled to the processor 16. The activation system 34 comprises a transmitter 36 which is in wireless communication with the transceiver 22. The transmitter 36 is operable to transmit a light activation signal to the processor 16 via the transceiver 22, and the processor 16 is programmed to activate the light emitter 18 upon receiving the light activation signal. The activation system 34 further comprises a manual actuator 38 and a plurality of hazard sensors 40 which are coupled to the transmitter 36. The manual actuator 38 is operable to cause the transmitter 36 to transmit the light activation signal to the processor 16. The manual actuator 38 may comprise a button, a switch, a touchscreen, or another suitable input such that the user may activate the light emitter 18 at will. Each hazard sensor 40 is configured to detect an associated hazardous parameter of a plurality of hazardous parameters. Hazardous parameters include indications that the safety of the dwelling 46 has been compromised including, for example, the presence of a hazardous substance such as smoke, carbon monoxide, natural gas, or the like, and the presence of other unsafe conditions such the opening of a door, a window, or the like which may indicate an intruder is breaking into the dwelling 46.

The hazard sensors 40 include a smoke alarm configured to detect the presence of smoke and a carbon monoxide detector configured to sense the presence of carbon monoxide. Other hazard sensors 40 may be included, such as positional detectors for detecting whether a door or window is open or closed, fire alarms, or detectors for sensing the presence of other hazardous substances such as natural gas. The hazard sensors 40 and the manual actuator 38 may be positioned remotely from the doorbell module 12 and may be in the dwelling 46 for example. In some embodiments, the manual actuator 38 and the hazard sensors 40 may be coupled to the processor 16 via wired connections.

In use, the doorbell module 12 may be used as described above to indicate when an individual is at the entryway 48 to the dwelling 46 and to facilitate communication between the user and the individual. The light emitter 18 of the doorbell module 12 may be activated to aid first responders 50 of the location of an emergency. For example, the manual actuator 38 may be manually actuated in the instance where the user or another calls an emergency service to obtain emergency service at the dwelling 46. When one of the hazard sensors 40 detects the associated hazardous parameter, the light emitter 18 is activated. The activation system 34 may also be part of or in communication with a security system which automatically dispatches emergency services when one of the hazardous parameters is detected.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An alert system for indicating a location of an emergency, the alert system comprising:
a doorbell module comprising:
a housing;
a processor mounted in the housing; and
a light emitter mounted on the housing, the light emitter being operably coupled to the processor; and
a manual actuator operatively coupled to the processor, the manual actuator being positioned remotely from the doorbell module, the manual actuator being operable to selectively cause the processor to activate the light emitter.

2. The alert system of claim 1, further comprising a hazard sensor, the hazard sensor being configured to detect a hazardous parameter, the hazard sensor being programmed to cause the processor to activate the light emitter upon detecting the hazardous parameter.

3. The alert system of claim 2, wherein the hazard sensor comprises a smoke alarm.

4. The alert system of claim 2, wherein the hazard sensor comprises a carbon monoxide detector.

5. The alert system of claim 1, wherein:
the doorbell module further comprises a transceiver mounted in the housing, the transceiver being operably coupled to the processor; and
further comprising a transmitter in wireless communication with the transceiver, the transmitter being operable to transmit a light activation signal to the processor via the transceiver, the processor being programmed to activate the light emitter upon receiving the light activation signal, the manual actuator being operatively coupled to the transmitter, the manual actuator being operable to cause the transmitter to transmit the light activation signal to the processor.

6. The alert system of claim 5, further comprising a hazard sensor, the hazard sensor being configured to detect a hazardous parameter, the hazard sensor being programmed to cause the transmitter to transmit the light activation signal to the processor upon detecting the hazardous parameter.

7. The alert system of claim 1, wherein the light emitter of the doorbell module is configured to emit a stroboscopic light pattern when activated.

8. The alert system of claim 1, wherein the processor of the doorbell module is configured to wirelessly communicate with a remote electronic device via the transceiver, the doorbell module further comprising:
a camera mounted to the housing, the camera being operably coupled to the processor; and
a microphone mounted to the housing, the microphone being operably coupled to the processor.

9. The alert system of claim 8, wherein the doorbell module further comprises a speaker mounted to the housing, the speaker being operably coupled to the processor.

10. The alert system of claim 1, wherein the doorbell module further comprises:
a speaker mounted to the housing, the speaker being operably coupled to the processor; and
a doorbell actuator mounted to the housing, the doorbell actuator being operatively coupled to the processor, the processor being configured to cause the speaker to emit an audible notification when the doorbell actuator is actuated.

11. The alert system of claim 1, wherein the doorbell module further comprises a power supply mounted in the housing, the power supply electrically coupled to the processor, the power supply comprising a battery.

12. An alert system for indicating a location of an emergency, the alert system comprising:
a doorbell module comprising:
a housing;
a processor mounted in the housing;
a light emitter mounted on the housing, the light emitter being operably coupled to the processor, the light emitter comprising a plurality of emitting members, the light emitter being configured to emit a stroboscopic light pattern when activated;
a transceiver mounted in the housing, the transceiver being operably coupled to the processor, the processor being configured to wirelessly communicate with a remote electronic device via the transceiver;
a camera mounted to the housing, the camera being operably coupled to the processor;
a microphone mounted to the housing, the microphone being operably coupled to the processor;
a speaker mounted to the housing, the speaker being operably coupled to the processor;
a doorbell actuator mounted to the housing, the doorbell actuator being operatively coupled to the processor, the processor being configured to cause the speaker to emit an audible notification when the doorbell actuator is actuated; and
a power supply mounted in the housing, the power supply electrically coupled to the processor, the power supply comprising a battery; and
an activation system operatively coupled to the processor, the activation system comprising:
a transmitter in wireless communication with the transceiver, the transmitter being operable to transmit a light activation signal to the processor via the transceiver, the processor being programmed to activate the light emitter upon receiving the light activation signal;
a manual actuator operatively coupled to the transmitter, the manual actuator being operable to cause the transmitter to transmit the light activation signal to the processor; and
a plurality of hazard sensors operatively coupled to the transmitter, each hazard sensor of the plurality of hazard sensors being configured to detect an associated hazardous parameter of a plurality of hazardous parameters, each hazard sensor of the plurality of hazard sensors being programmed to cause the transmitter to transmit the light activation signal to the processor upon detecting the associated hazardous parameter, the plurality of hazard sensors including a smoke alarm and a carbon monoxide detector.
